(19) United States
(12) Patent Application Publication
(10) Pub. No.: US 2024/0274338 A1
(43) Pub. Date: Aug. 15, 2024

(54) Permanent Magnet for Low Eddy-Current Loss of Permanent Magnet Motor and Permanent Magnet Motor

(71) Applicant: Yantai Dongxing Magnetic Materials Inc., Yantai, Shandong (CN)

(72) Inventors: Zhongjie PENG, Yantai, Shandong (CN); Xiaoqun LI, Yantai, Shandong (CN); Feng LIANG, Yantai, Shandong (CN); Kaihong DING, Yantai, Shandong (CN)

(21) Appl. No.: 18/289,749

(22) PCT Filed: May 10, 2022
(86) PCT No.: PCT/CN2022/092066

§ 371 Date: Nov. 7, 2023

Related U.S. Application Data
(60) Provisional application No. 63/186,880, filed on May 11, 2021.

(51) Int. Cl. H01F 7/02; H02K 1/08; H02K 1/276

(52) U.S. Cl. CPC H01F 7/021; H02K 1/08; H02K 1/276

(57) ABSTRACT

Some embodiments of the present disclosure provide a permanent magnet for low eddy-current loss of a permanent magnet motor and a permanent magnet motor. The permanent magnet includes a first magnetic pole surface, a second magnetic pole surface, four side surfaces, and a plurality of embedded electrical insulation layers. The first magnetic pole surface is basically orthogonal to a magnetization direction of the permanent magnet. The second magnetic pole surface is parallel to the first magnetic pole surface. The plurality of embedded electrical insulation layers are parallel to the magnetization direction of the permanent magnet; and at least one edge of each embedded electrical insulation layer is neither parallel nor perpendicular to the magnetization direction of the permanent magnet.

### CROSS-REFERENCE TO RELATED DISCLOSURE

The present disclosure is a national stage disclosure of International Patent Disclosure No. PCT/CN2022/092066, which is filed on May 10, 2022, and claims priority to U.S. Patent Disclosure No. 63/186,880, filed on May 11, 2021, and entitled “Permanent Magnet for Low Eddy-Current Loss of Permanent Magnet Motor and Permanent Magnet Motor”, the contents of which are hereby incorporated by reference in its entirety.

### TECHNICAL FIELD

The disclosure relates to a permanent magnet for low eddy-current loss of a permanent magnet motor and the permanent magnet motor with the permanent magnet, and relates to the field of permanent magnet motor.

### BACKGROUND ART

A permanent magnet motor includes a stator (not shown) and a rotor. As shown in FIG. 1, the rotor 100 is composed of a rotor core 102 made of laminated electrical steel and a plurality of permanent magnets 100 located in a rotor slot 104. After a coil in the stator of the motor is energized, a rotating magnetic field is generated. The rotating magnetic field interacts with a magnetic field generated by the permanent magnet of the rotor to generate a torque, causing the rotor to rotate. When an external magnetic field (the magnetic field generated by the coil of the stator) acts on each permanent magnet, an eddy current would be induced in the permanent magnet, thereby increasing a temperature of the permanent magnet. The increase in the temperature of the permanent magnet can lead to loss of magnetic flux of the permanent magnet, thereby reducing an output torque and efficiency of the permanent magnet motor.

At present, in order to reduce the loss of magnetic flux caused by the temperature rise of the permanent magnet due to the induced eddy current in the permanent magnet, the following methods are mainly used: 1: Improve the temperature resistance characteristic of the permanent magnet (especially the magnetic performance at a high temperature). This method would have a significant impact on the cost of the permanent magnet. 2: The eddy-current loss of the permanent magnet is reduced by using a split bonding manner (patent numbers CN104454852B, U.S. Pat. No. 7,973,442 B2), as shown in FIG. 2. This method would reduce the material utilization rate of the permanent magnet and increase the cost of the permanent magnet. 3: The permanent magnet adopts a manner of removing an electrical insulation layer of part of the material (patent number CN108631455A), as shown in FIG. 3A and FIG. 3B. The characteristic of this insulation layer slotting method is that an insulation layer in a slot is parallel to a magnetization direction, and edges of the insulation layer are parallel or perpendicular to the magnetization direction. FIG. 3C, FIG. 3D, FIG. 3E, and FIG. 3F show other methods for slotting magnets (patent numbers U.S. Ser. No. 10/666,099 B1 and U.S. Pat. No. 6,359,359 B1). The above three methods for reducing the eddy-current loss of the magnets will reduce, to a certain extent, a decrease in the output torque and efficiency of the permanent magnet motor due to the increase in the temperatures of the magnets, but these methods have a significant negative impact on the cost or magnetic flux of the permanent magnets.

FIG. 4A shows a typical rectangular structural shape of a permanent magnet. The permanent magnet has a magnetization direction, a first magnetic pole surface 418, a second magnetic pole surface 420, and side surfaces 410, 412, 414, and 416. As shown in an eddy current path 430 of the permanent magnet, the eddy current loss in the magnet is mainly concentrated in an edge region of the permanent magnet. As shown in FIG. 3A, FIG. 3C, and FIG. 3E, a method for forming an electrical insulation layer on a permanent magnet is to form slots in the permanent magnet to form the electrical insulation layer. These slots are distributed in the permanent magnet in a lengthwise or width direction of the magnet. Part of a permanent magnet material inside the slots is cut off. As a result, the volume of the permanent magnet is reduced, and significant loss of a magnetic flux is caused. As shown in FIG. 4A, FIG. 4B, and FIG. 4C, the eddy-current loss in a center of the magnet is relatively low, and the removal of the permanent magnet material in these regions has almost no effect on the reduction of the eddy-current loss. Due to the aforementioned method for slotting the permanent magnet, the electrical insulation layer penetrates through the permanent magnet in a thickness direction. As a result, some permanent magnet materials in a region with relatively low eddy current (a center region of the permanent magnet). Therefore, the aforementioned method for slotting the permanent magnet can lead to unnecessary loss of the magnetic flux of the permanent magnet. The above structural defects are also found in a non-rectangular polyhedral permanent magnet (such as a permanent magnet with a C-shaped cross section).

### SUMMARY OF THE INVENTION

Some embodiments of the present disclosure provide a permanent magnet for low eddy-current loss of a permanent magnet motor and a permanent magnet motor, to reduce loss caused by eddy current in the permanent magnet in the permanent magnet motor and reduce the loss of magnetic flux of the magnet, as well as avoid a significant increase in the costs of the permanent magnet.

In order to reduce the eddy-current loss of a permanent magnet and reduce unnecessary loss of magnetic flux of the magnet, the present disclosure provides a permanent magnet with a special structure. The permanent magnet provided by the present disclosure includes: a first magnetic pole surface, a second magnetic pole surface, four side surfaces, and a plurality of embedded electrical insulation layers. The first magnetic pole surface is orthogonal to a magnetization direction of the permanent magnet (A rectangular permanent magnet has a rectangular section, and the first magnetic pole surface is orthogonal to the magnetization direction of the permanent magnet, but a C-shaped permanent magnet has a C-shaped cross section, and the first magnetic pole surface is not completely orthogonal to the magnetization direction of the permanent magnet, forming a certain angle). The second magnetic pole surface is parallel to the first magnetic pole surface. The plurality of embedded electrical insulation layers are parallel to the magnetization direction of the permanent magnet; and at least one edge of each embedded electrical insulation layer is neither parallel nor perpendicular to the magnetization direction of the permanent magnet.

In some embodiments, each embedded electrical insulation layer is intersected with at least one edge of the permanent magnet at a predetermined angle in a lengthwise or width direction of the permanent magnet, and the predetermined angle ranges from 0° to 180°; and the at least one edge of the permanent magnet intersected with each embedded electrical insulation layer is defined as an intersected permanent magnet edge.

In some embodiments, the plurality of embedded electrical insulation layers are intersected with a same edge on the first magnetic pole surface in the lengthwise or width direction of the permanent magnet.

In some embodiments, the intersected permanent magnet edge comprises a first edge of the first magnetic pole surface and a second edge of the second magnetic pole surface in the lengthwise and width direction of the permanent magnet; or the intersected permanent magnet edge comprises a first edge of the first magnetic pole surface and a second edge of the second magnetic pole surface in the lengthwise direction of the permanent magnet; or the intersected permanent magnet edge comprises a first edge of the first magnetic pole surface and a second edge of the second magnetic pole surface in the width direction of the permanent magnet; the first edge and the second edge are parallel.

In some embodiments, the predetermined angle is 90°.

In some embodiments, each embedded electrical insulation layer is intersected with at least two edges of the permanent magnet at a predetermined angle in a lengthwise or width direction of the permanent magnet, and the predetermined angle ranges from 0° to 180°; and the at least two edges of the permanent magnet intersected with each embedded electrical insulation layer are defined as intersected permanent magnet edges.

In some embodiments, the intersected permanent magnet edges comprise a first edge, a second edge, a third edge and a fourth edge, the first edge and the second edge are disposed on the first magnetic pole surface in the lengthwise direction of the permanent magnet; or the first edge and the second edge are disposed on the first magnetic pole surface in the width direction of the permanent magnet, the first edge and the second edge are parallel; or the first edge and the second edge are disposed on the first magnetic pole surface in the lengthwise and width direction of the permanent magnet, the first edge and the second edge are parallel; the first edge and the second edge are parallel; the third edge and the fourth edge are disposed on the second magnetic pole surface in the lengthwise direction of the permanent magnet; or the third edge and the fourth edge are disposed on the second magnetic pole surface in the width direction of the permanent magnet; or the third edge and the fourth edge are disposed on the second magnetic pole surface in the lengthwise and width direction of the permanent magnet; the third edge and the fourth edge are parallel.

In some embodiments, the intersected permanent magnet edges comprise a first edge and a second edge, the first edge and the second edge are disposed on the first magnetic pole surface; or the first edge and the second edge are disposed on the second magnetic pole surface; or the first edge is disposed on the first magnetic pole surface and the second edge is disposed on the second magnetic pole surface; the first edge and the second edge are perpendicularly intersected.

In some embodiments, each embedded electrical insulation layer is intersected with one set of opposite angles of the first magnetic pole surface in a diagonal direction of the permanent magnet or each embedded electrical insulation layer is intersected with one set of opposite angles of the second magnetic pole surface in a diagonal direction of the permanent magnet; or each embedded electrical insulation layer is intersected with one set of opposite angles of the first magnetic pole surface and the second magnetic pole surface in a diagonal direction of the permanent magnet.

In some embodiments, each embedded electrical insulation layer is intersected with two sets of opposite angles of the first magnetic pole surface in a diagonal direction of the permanent magnet; or each embedded electrical insulation layer is intersected with two sets of opposite angles of the second magnetic pole surface in a diagonal direction of the permanent magnet; or each embedded electrical insulation layer is intersected with two sets of opposite angles of the first magnetic pole surface and the second magnetic pole surface in a diagonal direction of the permanent magnet.

In some embodiments, at least one of the embedded electrical insulation layers is intersected with an edge of the first magnetic pole surface; or at least one of the embedded electrical insulation layers is intersected with an edge of the second magnetic pole surface; or at least one of the embedded electrical insulation layers is intersected with an edge of the first magnetic pole surface and the second magnetic pole surface, and at least one embedded electrical insulation layer is intersected with one set of opposite angles of the first magnetic pole surface; or at least one embedded electrical insulation layer is intersected with one set of opposite angles of the second magnetic pole surface; or at least one embedded electrical insulation layer is intersected with one set of opposite angles of the first magnetic pole surface and the second magnetic pole surface.

In some embodiments, each embedded electrical insulation layer is intersected with three edges of the permanent magnet at a predetermined angle in the lengthwise or width direction of the permanent magnet, and the predetermined angle ranges from 0° to 180°.

In some embodiments, each embedded electrical insulation layer is intersected with four edges of the permanent magnet at a predetermined angle in the lengthwise or width direction of the permanent magnet, and the predetermined angle ranges from 0° to 180°.

In some embodiments, a slot is disposed in the permanent magnet; and the slot is filled with an insulation material or air, or an electrical insulation surface layer is disposed on an inner wall of the slot to obtain the embedded electrical insulation layer.

In some embodiments, a cross section of the permanent magnet is rectangular or C-shaped.

Some embodiment of the present invention further provides a permanent magnet motor, comprising a stator, a rotor supported to rotate relative to the stator, and a plurality of permanent magnets disposed on the rotor, the permanent magnet is the above permanent magnet; a first magnetic pole surface of the permanent magnet faces away from a center of the rotor in a radius direction of the rotor; and a second magnetic pole surface of the permanent magnet faces the center of the rotor in a radius of the rotor.

In some embodiments, the permanent magnets are disposed in a rotor slot of the rotor or on an outer surface of the rotor.

Applying the technical solution of this disclosure, the electrical insulation layers in the permanent magnet provided by the present disclosure are located in a region of the permanent magnet having high eddy-current loss. Since the electrical insulation layers are not arranged in a region of the permanent magnet having low eddy-current loss, the permanent magnet provided by the present disclosure can retain a material in the permanent magnet region to the maximum extent, which reduces the loss of magnetic flux caused by the introduction of the embedded electrical insulation layers, and, to a certain extent, which avoids an increase in the costs while playing a role in reducing the eddy-current loss.

### BRIEF DESCRIPTION OF THE DRAWINGS

FIG. 1 illustrates a schematic diagram of a rotor of an IPM structure of a permanent magnet motor according to the art known to inventors.

FIG. 2 illustrates a schematic diagram of a representative segmented permanent magnet according to the art known to inventors.

FIG. 3A illustrates a front view of a representative insulation layer permanent magnet according to the art known to inventors.

FIG. 3B illustrates a top view of FIG. 3A.

FIG. 3C illustrates a schematic diagram of another representative insulation layer permanent magnet according to the art known to inventors.

FIG. 3D illustrates a schematic diagram of a section A in FIG. 3C.

FIG. 3E illustrates a schematic diagram of still another representative insulation layer permanent magnet according to the art known to inventors.

FIG. 3F illustrates a schematic diagram of a section A in FIG. 3E.

FIG. 4A illustrates a schematic diagram of distribution of eddy current generated in a permanent magnet.

FIG. 4B illustrates a schematic diagram of distribution of eddy current generated by the permanent magnet shown in FIG. 4A at a section A.

FIG. 4C illustrates a schematic diagram of distribution of eddy current generated by the permanent magnet shown in FIG. 4A at a section B.

FIG. 5A illustrates a perspective diagram of a structure of Embodiment 1 of the present disclosure.

FIG. 5B illustrates a schematic diagram of a section A in FIG. 5A.

FIG. 5C illustrates a perspective diagram of another structure of the Embodiment 1 of the present disclosure.

FIG. 5D illustrates a schematic diagram of a section A in FIG. 5C.

FIG. 5E illustrates a perspective diagram of still another structure of the Embodiment 1 of the present disclosure.

FIG. 5F illustrates a schematic diagram of a section A in FIG. 5E.

FIG. 5G illustrates a schematic diagram of a section B in FIG. 5E.

FIG. 5H illustrates a perspective diagram of yet another structure of the Embodiment 1 of the present disclosure.

FIG. 5I illustrates a schematic diagram of a section A in FIG. 5H.

FIG. 5J illustrates a perspective diagram of still yet another structure of the Embodiment 1 of the present disclosure.

FIG. 5K illustrates a schematic diagram of a section A in FIG. 5J.

FIG. 5L illustrates a schematic diagram of a section B in FIG. 5J.

FIG. 5M illustrates a perspective diagram of still yet another structure of the Embodiment 1 of the present disclosure.

FIG. 5N illustrates a schematic diagram of a section A in FIG. 5M.

FIG. 5O illustrates a schematic diagram of a section B in FIG. 5M.

FIG. 6A illustrates a perspective diagram of a structure of a Embodiment 2 of the present disclosure.

FIG. 6B illustrates a schematic diagram of a section A in FIG. 6A.

FIG. 6C illustrates a perspective diagram of another structure of the Embodiment 2 of the present disclosure.

FIG. 6D illustrates a schematic diagram of a section A in FIG. 6C.

FIG. 7A illustrates a perspective diagram of a structure of a Embodiment 3 of the present disclosure.

FIG. 7B illustrates a schematic diagram of a section A in FIG. 6D.

FIG. 8A illustrates a perspective diagram of a structure of a Embodiment 4 of the present disclosure.

FIG. 8B illustrates a schematic diagram of a section A in FIG. 8A.

FIG. 8C illustrates a schematic diagram of a section B in FIG. 8A.

FIG. 8D illustrates a perspective diagram of another structure of the Embodiment 4 of the present disclosure.

FIG. 8E illustrates a schematic diagram of a section A in FIG. 8D.

FIG. 9A illustrates a perspective diagram of a structure of a Embodiment 5 of the present disclosure.

FIG. 9B illustrates a schematic diagram of a section A in FIG. 9A.

FIG. 9C illustrates a schematic diagram of a section B in FIG. 9A.

FIG. 9D illustrates a schematic diagram of a section C in FIG. 9A.

FIG. 9E illustrates a perspective diagram of another structure of the Embodiment 5 of the present disclosure.

FIG. 9F illustrates a schematic diagram of a section A in FIG. 9E.

FIG. 9G illustrates a schematic diagram of a section B in FIG. 9E.

FIG. 9H illustrates a schematic diagram of a section C in FIG. 9E.

FIG. 9I illustrates a perspective diagram of still another structure of the Embodiment 5 of the present disclosure.

FIG. 9J illustrates a schematic diagram of a section A in FIG. 9I.

FIG. 9K illustrates a schematic diagram of a section B in FIG. 9I.

FIG. 9L illustrates a schematic diagram of a section C in FIG. 9I.

FIG. 10A illustrates a perspective diagram of a structure of a Embodiment 6 of the present disclosure.

FIG. 10B illustrates a schematic diagram of a section A in FIG. 10A.

FIG. 11A illustrates a perspective diagram of a structure of a Embodiment 7 of the present disclosure.

FIG. 11B illustrates a schematic diagram of a section A in FIG. 11A.

FIG. 12A illustrates a perspective diagram of a structure of an Embodiment 8 of the present disclosure.

FIG. 12B illustrates a schematic diagram of a section A in FIG. 12A.

FIG. 12C illustrates a schematic diagram of a section B in FIG. 12A.

FIG. 13A illustrates a schematic diagram of a perspective diagram of a structure of a Embodiment 9 of the present disclosure and a section A.

FIG. 13B illustrates a schematic diagram of a section A in FIG. 13A.

FIG. 14A illustrates a perspective diagram of a structure of a Embodiment 10 of the present disclosure.

FIG. 14B illustrates a schematic diagram of a section A in FIG. 14A.

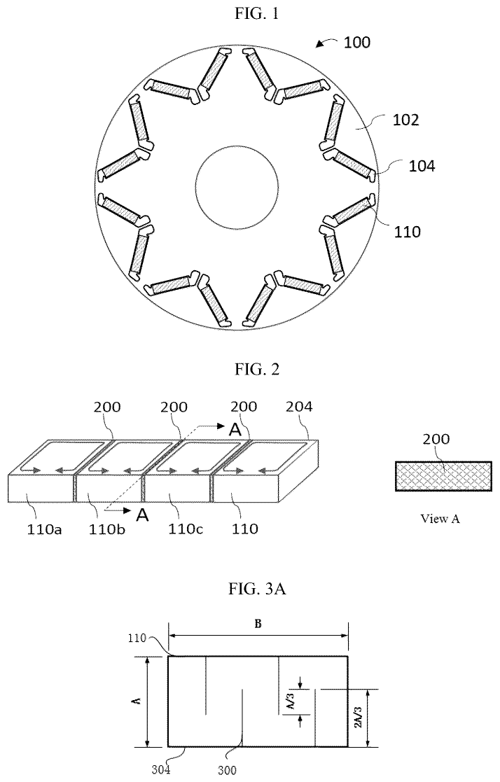

### DETAILED DESCRIPTION OF THE INVENTION

The embodiments of the present disclosure are further described below in combination with the accompanying drawings.

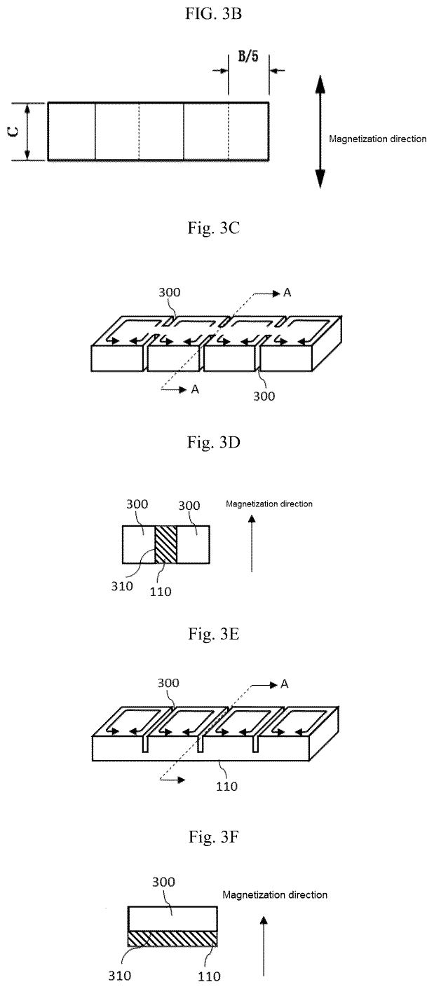

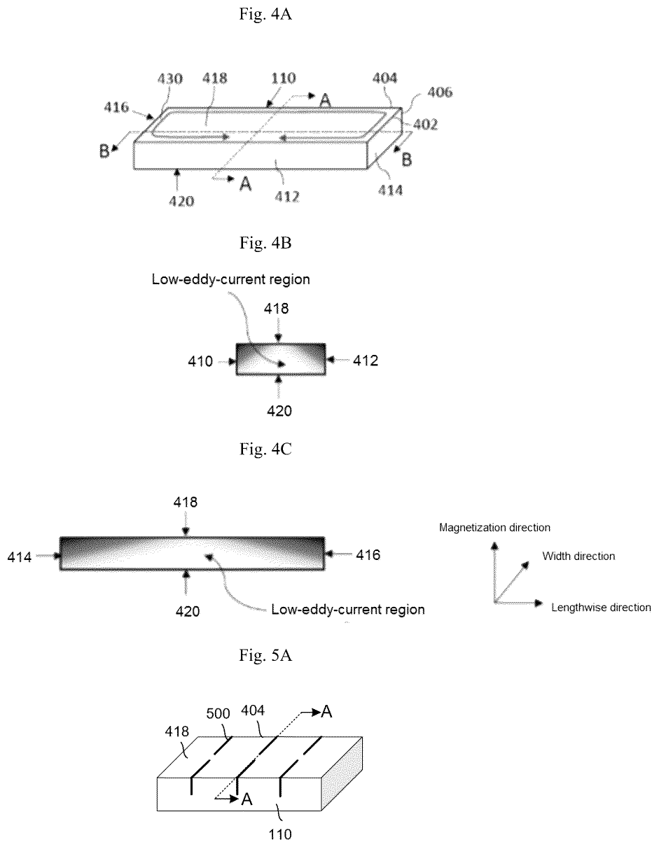

Based on an existing technology for reducing eddy current, the present disclosure studies an eddy current reduction solution in other views. As shown in FIG. 3A, FIG. 3B, FIG. 3C, FIG. 3D, FIG. 3E, and FIG. 3F, a permanent magnet is slotted to form electrical insulation layers. These slots are distributed in the permanent magnet in a lengthwise or width direction of the magnet. Part of a permanent magnet material inside the slots is cut off. As a result, the volume of the permanent magnet is reduced, and significant loss of a magnetic flux is caused. As shown in FIG. 4A, FIG. 4B, and FIG. 4C, a center region and a lower region of the magnet have relatively low eddy current, and the removal of the permanent magnet material in these regions has almost no effect on the reduction of the eddy current.

Therefore, the present disclosure aims to minimize the loss of magnetic flux caused by the introduction of an electrical insulation layer to a permanent magnet. Removal of a permanent magnet material at a center of the permanent magnet is avoided as much as possible by adjusting a shape and position distribution of the electrical insulation layer, and a thickness of the electrical insulation layer is relatively small (≥0.3 mm). This method can retain the magnetic flux of the permanent magnet to the largest extent.

Several embodiments of permanent magnets with electrical insulation layers of the present disclosure will be explained according to the accompanying drawings.

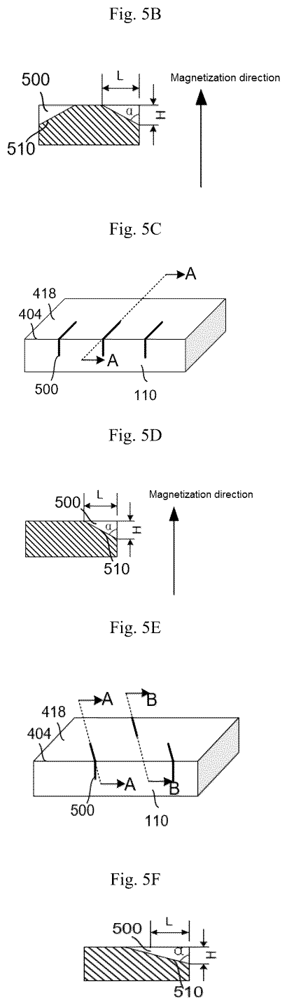

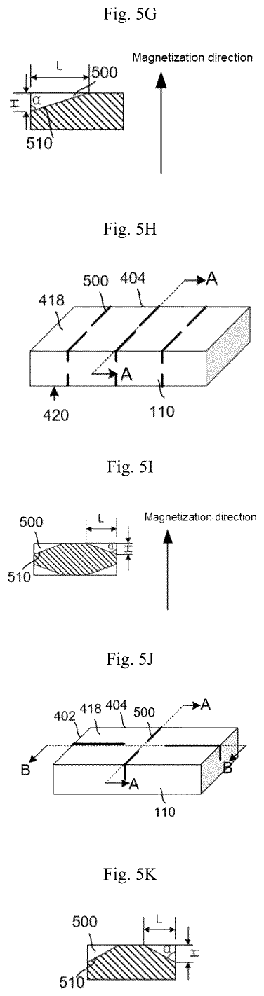

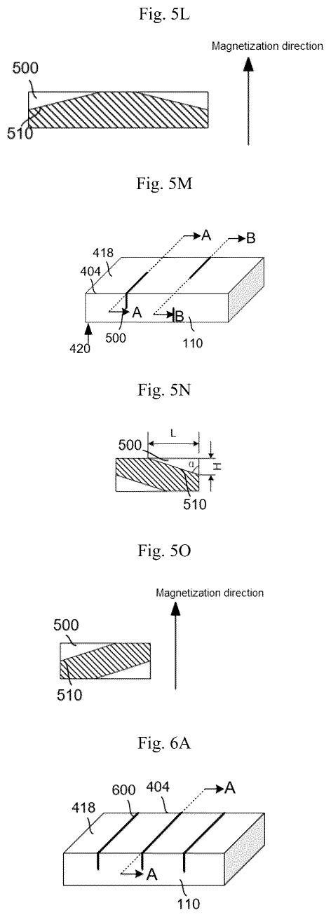

As shown in FIG. 5A, FIG. 5C, FIG. 5E, FIG. 5H, FIG. 5J, and FIG. 5M, each embedded electrical insulation layer is intersected with a single edge of the first magnetic pole surface or the second magnetic pole surface of the permanent magnet, and forms a predetermined angle with the intersected magnet edge.

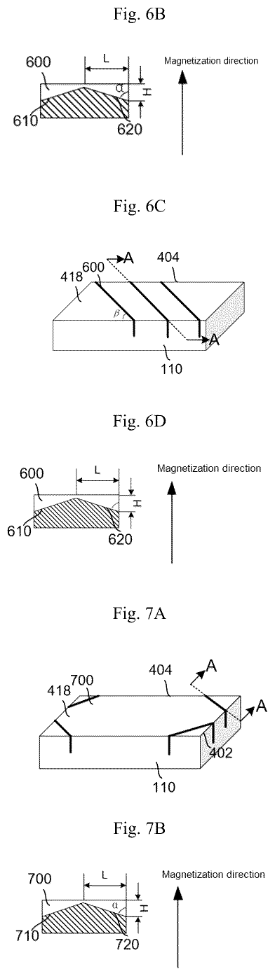

As shown in FIG. 6A and FIG. 6C, each embedded electrical insulation layer is intersected with two parallel edges of the permanent magnet in the lengthwise or width direction.

As shown in FIG. 7A, each embedded electrical insulation layer is intersected with two intersected edges of the first magnetic pole surface or the second magnetic pole surface.

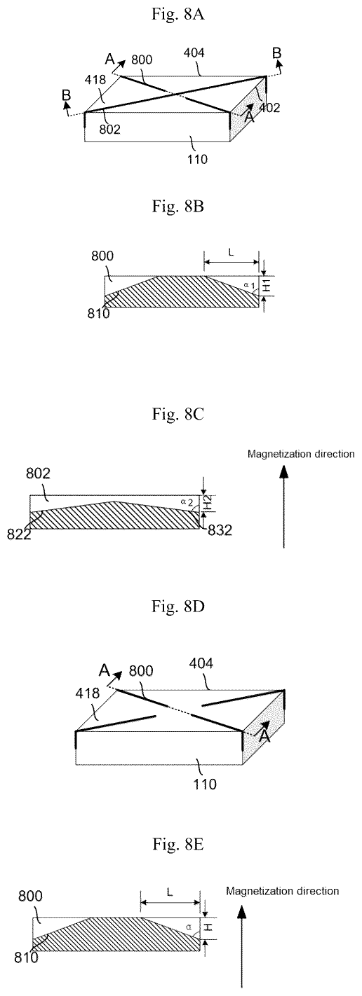

As shown in FIG. 8A and FIG. 8D, each embedded electrical insulation layer is intersected with an angle of the first magnetic pole surface or the second magnetic pole surface and along a diagonal direction of the permanent magnet.

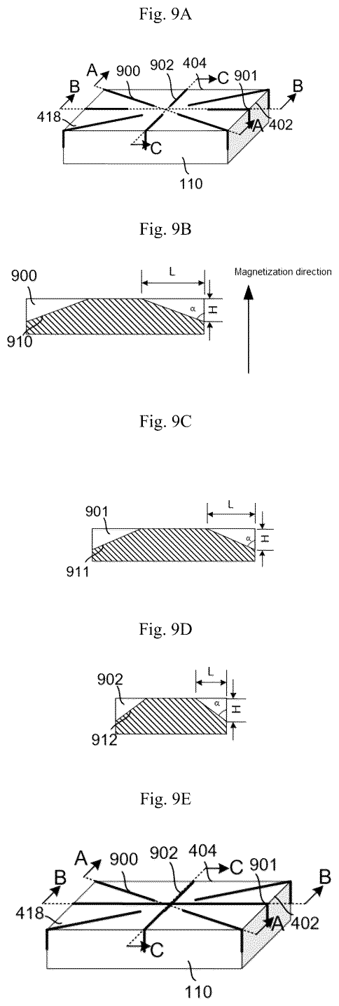

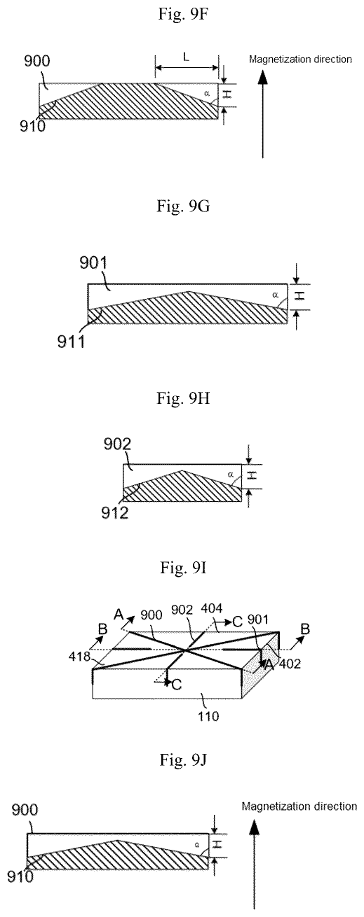

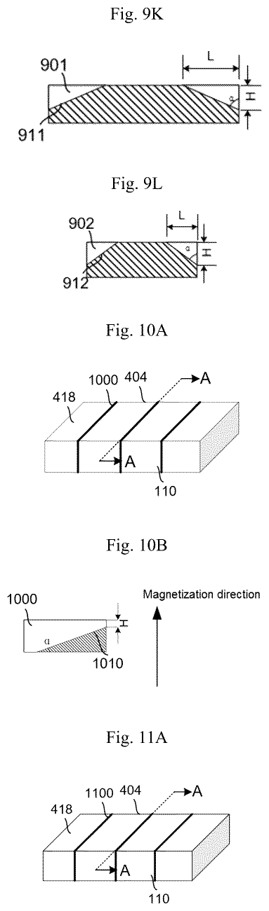

FIG. 9A, FIG. 9E, and FIG. 9I show a shape of the embedded electrical insulation layer formed by arbitrarily combining the above several methods and distribution of the electrical insulation layer in the permanent magnet. The electrical insulation layer is intersected with the first magnetic pole surface or the second magnetic pole surface.

As shown in FIG. 10A, each embedded electrical insulation layer is intersected with three edges of the permanent magnet in the lengthwise or width direction.

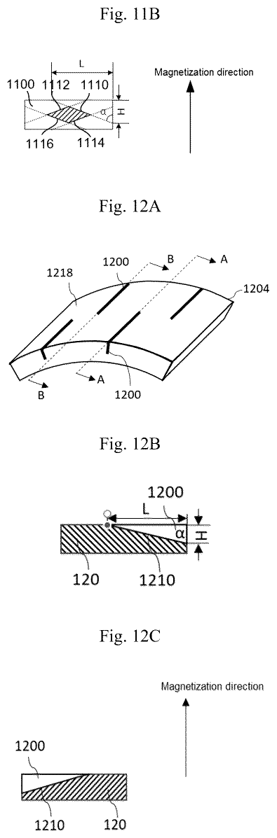

As shown in FIG. 11A, each embedded electrical insulation layer is intersected with four edges of the permanent magnet in the lengthwise or width direction.

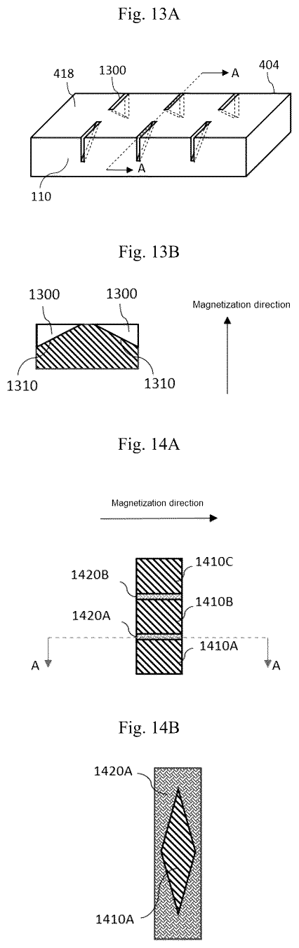

As shown in FIG. 12A, each embedded electrical insulation layer is intersected with an edge of the permanent magnet in the lengthwise or width direction.

A material of the above electrical insulation layer can be ceramic, epoxy resin, air, or a mixture of several insulation materials. For example, slotting on a sintered permanent magnet can cause the permanent magnet to have an electrical insulation layer using air as an insulation material (air itself is insulated, which naturally fills slots to form the electrical insulation layers). After the permanent magnet is slotted, epoxy resin or another insulation material fills the slots to obtain the electrical insulation layers made of different insulation materials in the permanent magnet. In a production process of the permanent magnet, if a layer of ceramic powder is laid at a position of the electrical insulation layer in a powdered permanent magnet material billet and is then pressed and sintered, the permanent magnet can have an electrical insulation layer using ceramic as an insulation material.

The common characteristic of the above electrical insulation layers is that the electrical insulation layers are parallel to the magnetization direction of the permanent magnet, and each electrical insulation layer has at least one edge that is neither parallel nor perpendicular to the magnetization direction of the permanent magnet. The edge is at a certain angle α to the magnetization direction, and the angle α ranges from 0° to 180°, and is not equal to 90°. In addition, areas of all the electrical insulation layers on the permanent magnet constitute a total area of the electrical insulation layers. The total area of the electrical insulation layers depends on a requirement for reducing the eddy-current loss of the permanent magnet.

FIG. 5A and FIG. 5B show a structure of an Embodiment 1 of the present disclosure. A first magnetic pole surface 418 of the permanent magnet is intersected with at least one embedded electrical insulation layer 500, and each embedded electrical insulation layer 500 is orthogonal to one edge 404 of the first magnetic pole surface 418 in a lengthwise direction of the permanent magnet (or each electrical insulation layer can be orthogonal to one edge 402 of the first magnetic pole surface 418 in a width direction of the permanent magnet, not shown). An edge 510 of each embedded electrical insulation layer 500 is neither parallel nor orthogonal to a magnetization direction of the permanent magnet. Dimensions L and H, an angle α, and a quantity of the embedded electrical insulation layer are determined according to a total area of the embedded electrical insulation layer.

FIG. 5C and FIG. 5D show another structure of an Embodiment 1 of the present disclosure. A first magnetic pole surface 418 of a permanent magnet is intersected with at least one embedded electrical insulation layer 500, and each embedded electrical insulation layer is only intersected with one edge 404 of the first magnetic pole surface 418 in a lengthwise direction of the permanent magnet (or each embedded electrical insulation layer can be only intersected with one edge 402 of the first magnetic pole surface 418 in a width direction of the permanent magnet, not shown). An edge 510 of each embedded electrical insulation layer 500 is neither parallel nor orthogonal to a magnetization direction of the permanent magnet. This embedded electrical insulation layer method can minimize the loss of magnetic flux caused by the introduction of the embedded electrical insulation layer to the permanent magnet when eddy current is only concentrated on one side of the permanent magnet. Dimensions L and H, an angle α, and a quantity of the embedded electrical insulation layer are determined according to a total area of the embedded electrical insulation layer.

FIG. 5E, FIG. 5F, and FIG. 5G show still another structure of the Embodiment 1 of the present disclosure. A first magnetic pole surface 418 of a permanent magnet is intersected with at least one embedded electrical insulation layer 500. One part of the embedded electrical insulation layer 500 is intersected with one edge 404 of the first magnetic pole surface 418 at a certain angle in a lengthwise direction of the permanent magnet, and another part of the embedded electrical insulation layer is intersected with another edge 404 of the first magnetic pole surface at a predetermined angle in the lengthwise direction of the permanent magnet (it can also be that one part of the embedded electrical insulation layer 500 is intersected with one edge 402 on the first magnetic pole surface 418 at a predetermined angle in a width direction of the permanent magnet, and another part of the embedded electrical insulation layer 500 is intersected with one edge 402 of a second magnetic pole surface 420 at a predetermined angle in the width direction of the permanent magnet, not shown). The embedded electrical insulation layer is parallel to a magnetization direction of the permanent magnet, and an edge 510 of each embedded electrical insulation layer 500 is neither parallel nor orthogonal to a magnetization direction of the permanent magnet. An predetermined angle between the embedded electrical insulation layer and a permanent magnet edge 404 intersected with the embedded electrical insulation layer is not equal to 90°. Dimensions L and H, an angle α, and a quantity of the embedded electrical insulation layer are determined according to a total area of the embedded electrical insulation layer.

FIG. 5H and FIG. 5I show yet another structure of the Embodiment 1 of the present disclosure. A first magnetic pole surface 418 and a second magnetic pole surface 420 of a permanent magnet are intersected with at least one embedded electrical insulation layer 500. One group of embedded electrical insulation layers 500 are orthogonal to one edge 404 of the first magnetic pole surface 418 in a lengthwise direction of the permanent magnet, and another group of embedded electrical insulation layers 500 are orthogonal to one edge 404 of the second magnetic pole surface 420 in the lengthwise direction of the permanent magnet (it can also be that one group of embedded electrical insulation layers 500 are orthogonal to one edge 402 of the first magnetic pole surface 418 in a width direction of the permanent magnet, and another group of embedded electrical insulation layers 500 are orthogonal to one edge 402 of the second magnetic pole surface 420 in the width direction of the permanent magnet, not shown). An edge 510 of each embedded electrical insulation layer 500 is neither parallel nor orthogonal to a magnetization direction of the permanent magnet. Dimensions L and H, an angle α, and a quantity of the electrical insulation layer are determined according to a total area of the embedded electrical insulation layer.

FIG. 5J, FIG. 5K, and FIG. 5L show still yet another structure of the Embodiment 1 of the present disclosure. A first magnetic pole surface 418 of a permanent magnet is intersected at least one embedded electrical insulation layer 500. One group of embedded electrical insulation layers are orthogonal to two parallel edges 404 of the first magnetic pole surface 418 in a lengthwise direction of the permanent magnet, and another group of embedded electrical insulation layers are orthogonal to two parallel edges 402 of the first magnetic pole surface 418 in a width direction of the permanent magnet. Each embedded electrical insulation layer 500 is intersected with only one edge of the permanent magnet, and an edge 510 of each embedded electrical insulation layer 500 is neither parallel nor orthogonal to a magnetization direction of the permanent magnet. Dimensions L and H, an angle α, and a quantity of the electrical insulation layer are determined according to a total area of the embedded electrical insulation layer.

FIG. 5M, FIG. 5N, and FIG. 5O show still yet another structure of the Embodiment 1 of the present disclosure. A first magnetic pole surface 418 and a second magnetic pole surface 420 of a permanent magnet are intersected with at least one embedded electrical insulation layer 500. Some embedded electrical insulation layers 500 are orthogonal to an edge 404 of the first magnetic pole surface 418 in a lengthwise direction, and some other embedded electrical insulation layers are intersected with an edge 404 of the second magnetic pole surface 420 in the lengthwise direction. Each embedded electrical insulation layer is intersected with only one edge 404 of the magnet, and a depth of the embedded electrical insulation layer is not equal to a thickness of the permanent magnet. The embedded electrical insulation layer is parallel to a magnetization direction of the magnet (it can also be that some embedded electrical insulation layers 500 are intersected with an edge 402 of the first magnetic pole surface 418 in a width direction, while some other embedded electrical insulation layers are intersected with an edge 402 of the second magnetic pole surface 420 in the width direction. Each embedded electrical insulation layer is intersected with only one edge 402 of the magnet, not shown). An edge 510 of each embedded electrical insulation layer is neither parallel nor orthogonal to a magnetization direction of the magnet. Dimensions L and H, an angle α, and a quantity of the electrical insulation layer are determined according to a total area of the embedded electrical insulation layer.

FIG. 6A and FIG. 6B show a structure of an Embodiment 2 of the present disclosure. A first magnetic pole surface 418 of a permanent magnet is intersected with at least one embedded electrical insulation layer 600. Each embedded electrical insulation layer 600 is orthogonal to two parallel edges 404 of the first magnetic pole surface 418 in a lengthwise direction of the permanent magnet (or, each electrical insulation layer can be orthogonal to two parallel edges 402 of the first magnetic pole surface 418 in a width direction of the permanent magnet). The embedded electrical insulation layer is parallel to a magnetization direction of the permanent magnet. Two edges 610 and 620 of each embedded electrical insulation layer 600 are neither parallel nor orthogonal to a magnetization direction of the permanent magnet. Dimensions L and H, an angle α, and a quantity of the electrical insulation layer are determined according to a total area of the embedded electrical insulation layer.

FIG. 6C and FIG. 6D show another structure of the Embodiment 2 of the present disclosure. A first magnetic pole surface 418 of a permanent magnet is intersected with at least one embedded electrical insulation layer 600. Each embedded electrical insulation layer is intersected with two parallel edges 404 of the first magnetic pole surface 418 in a lengthwise direction of the permanent magnet, and the embedded electrical insulation layer and the edges 404 are intersected at an angle β (or, each electrical insulation layer can also be intersected with two parallel edges 402 of the first magnetic pole surface 418 in a width direction of the permanent magnet, and the embedded electrical insulation layer and the edges 402 are intersected at an angle β, not shown). In addition, two edges 610 and 620 of each embedded electrical insulation layer 600 are neither parallel nor orthogonal to a magnetization direction of the permanent magnet, and the angle ß is not 90°. Dimensions L and H, an angle α, and a quantity of the embedded electrical insulation layer are determined according to a total area of the embedded electrical insulation layer.

FIG. 7A and FIG. 7B show a structure of an Embodiment 3 of the present disclosure. A first magnetic pole surface 418 of the permanent magnet is intersected with at least one embedded electrical insulation layer 700. Each embedded electrical insulation layer is intersected with only two intersected edges (edge 404 and edge 402) of the first magnetic pole surface 418, and two edges 710 and 720 of each embedded electrical insulation layer 700 are neither parallel nor orthogonal to a magnetization direction of the permanent magnet. Dimensions L and H, an angle α, and a quantity of the electrical insulation layer are determined according to a total area of the embedded electrical insulation layer.

FIG. 8A, FIG. 8B, and FIG. 8C show a structure of an Embodiment 4 of the present disclosure. A first magnetic pole surface 418 of a permanent magnet is intersected with two groups of embedded electrical insulation layers 800 and 802. One group of embedded electrical insulation layers 800 are intersected with one angle of the first magnetic pole surface 418 in a diagonal direction of the permanent magnet, and the other group of embedded electrical insulation layers 802 are intersected with two angles of the first magnetic pole surface 418 in the diagonal direction of the permanent magnet. An edge 810 of each embedded electrical insulation layer 800 and two edges 822 and 832 of each electrical insulation layer 802 are neither parallel nor orthogonal to a magnetization direction of the magnet. Dimensions L and H, an angle α, and a quantity of the electrical insulation layer are determined according to a total area of the embedded electrical insulation layer.

FIG. 8D and FIG. 8E show another structure of the Embodiment 4 of the present disclosure. A first magnetic pole surface 418 of a permanent magnet is intersected with at least one embedded electrical insulation layer 800, and each embedded electrical insulation layer 800 is intersected with one angle of the first magnetic pole surface 418 in a diagonal direction of the permanent magnet. An edge 810 of each embedded electrical insulation layer 800 is neither parallel nor orthogonal to a magnetization direction of the magnet. Dimensions L and H, an angle α, and a quantity of the embedded electrical insulation layer are determined according to a total area of the embedded electrical insulation layer.

FIG. 9A, FIG. 9B, FIG. 9C, and FIG. 9D show a first structure of an Embodiment 5 of the present disclosure. FIG. 9E, FIG. 9F, FIG. 9G, and FIG. 9H show a second structure of the Embodiment 5 of the present disclosure. FIG. 9I, FIG. 9J, FIG. 9K, and FIG. 9L show a third structure of the Embodiment 5 of the present disclosure. The arrangement structures of the various embedded electrical insulation layers in the permanent magnet mentioned in the Embodiment 1 to Embodiment 4 of the present disclosure can be arbitrarily combined to form new embedded electrical insulation layers (900, 901, and 902). The embedded electrical insulation layers (900, 901, and 902) are parallel to a magnetization direction of the magnet, and each embedded electrical insulation layer has at least one edge (910, 911, 912) that is neither parallel nor orthogonal to a magnetization direction of the magnet. Dimensions L and H, a, and a quantity of the embedded electrical insulation layer are determined according to a total area of the embedded electrical insulation layer.

FIG. 10A and FIG. 10B show a structure of an Embodiment 6 of the present disclosure. At least one embedded electrical insulation layer 1000 is intersected with a permanent magnet 110. The embedded electrical insulation layer 1000 is intersected with three parallel edges 404 of the permanent magnet along a length of the permanent magnet (or the embedded electrical insulation layer can be intersected with three parallel edges 402 of the permanent magnet in a width direction of the permanent magnet). The embedded electrical insulation layer is parallel to a magnetization direction of the permanent magnet, and an edge 1010 of each embedded electrical insulation layer 1000 is neither parallel nor orthogonal to the magnetization direction of the permanent magnet. Dimensions L and H, an angle α, and a quantity of the embedded electrical insulation layer are determined according to a total area of the embedded electrical insulation layer.

FIG. 11A and FIG. 11B show a structure of an Embodiment 7 of the present disclosure. At least one embedded electrical insulation layer 1100 is intersected with a permanent magnet 110.

The embedded electrical insulation layer 1100 is intersected with four parallel edges 404 of the permanent magnet in a lengthwise direction of the permanent magnet (or the electrical insulation layer can be intersected with four parallel edges 402 of the permanent magnet in a width direction of the permanent magnet). The embedded electrical insulation layer is parallel to a magnetization direction of the magnet, and four edges 1110, 1112, 1114, and 1116 of each embedded electrical insulation layer are neither parallel nor orthogonal to a magnetization direction of the permanent magnet. A dimension H, an angle α, and a quantity of the embedded electrical insulation layer are determined according to a total area of the embedded electrical insulation layer.

FIG. 12A, FIG. 12B, and FIG. 12C show a structure of an Embodiment 8 of the present disclosure. An embedded electrical insulation layer 1200 is intersected with one edge 1204 of the permanent magnet 120 in a tangential direction of an outer pole surface 1218 of a C-shaped permanent magnet 120. The embedded electrical insulation layer 1200 is parallel to a magnetization direction of the magnet, and an edge 1210 of each embedded electrical insulation layer is neither parallel nor orthogonal to the magnetization direction of the magnet. Dimensions L and H, a, and a quantity of the embedded electrical insulation layer are determined according to a total area of the embedded electrical insulation layer.

FIG. 13A and FIG. 13B show a structure of an Embodiment 9 of the present disclosure. A first magnetic pole surface 418 of a permanent magnet is intersected with at least one slot 1300, and each slot 1300 is orthogonal to one edge 404 of the first magnetic pole surface 418 in a lengthwise direction of the permanent magnet (or each slot can be orthogonal to one edge 402 of the first magnetic pole surface 418 in a width direction of the permanent magnet). An edge 1310 of each slot 1300 is neither parallel nor orthogonal to a magnetization direction of the permanent magnet. An insulation material of an embedded electrical insulation layer in the permanent magnet is air in an open slot.

FIG. 14A and FIG. 14B show a structure of an Embodiment 10 of the present disclosure. A layer of powdered insulation material 1420A is placed at a top of a layer of powdered permanent magnet material 1410A. The powdered insulation material layer 1420A does not completely cover the powdered permanent magnet material layer 1410A, to form a double-layer powdered permanent magnet material block. Several double-layer powdered permanent magnet material blocks are stacked together to form a multi-layer powdered permanent magnet material block 1400. The multi-layer powdered permanent magnet material block 1400 is oriented and pressed. The formed multi-layer permanent magnet material body is sintered. The sintered multi-layer permanent magnet material body is annealed.

The above embodiments have the common characteristics that the embedded electrical insulation layers are only distributed in regions with the highest eddy current density (the black regions in view A and view B of FIG. 4), which avoids removal of permanent magnet materials in regions with relatively low eddy current, namely, a center region of the magnet, thereby reducing the loss of magnetic flux of the permanent magnet caused by the introduction of the electrical insulation layers to the permanent magnet and maintaining the same effect of reducing the eddy current loss.

The above structures are main forms of embedded electrical insulation layers for a permanent magnet provided in the present disclosure. Its main structural characteristic is that a permanent magnet includes at least one embedded electrical insulation layer, and each embedded electrical insulation layer has at least one edge that is neither parallel nor orthogonal to a magnetization direction of the permanent magnet. Of course, the structure of the embedded electrical insulation layer structure involved in the present disclosure is not limited to the above structures, and can be achieved through various combinations and changes in a direction of the embedded electrical insulation layer, but its characteristics follow the above structural characteristics.

A permanent magnet motor of the present disclosure includes a stator, a rotor supported to rotate relative to the stator, and a plurality of permanent magnets of the present disclosure mounted on the rotor.

The first magnetic pole surface faces away from a center of the rotor in a radius direction of the rotor; and the second magnetic pole surface faces the center of the rotor in a radius of the rotor. The permanent magnets are disposed in a rotor slot of the rotor or on an outer surface of the rotor.

What is claimed is:

1. A permanent magnet for low eddy-current loss of a permanent magnet motor, comprising a first magnetic pole surface, a second magnetic pole surface, four side surfaces and a plurality of embedded electrical insulation layers, wherein the first magnetic pole surface is orthogonal to a magnetization direction of the permanent magnet; the second magnetic pole surface is parallel to the first magnetic pole surface; the plurality of embedded electrical insulation layers are parallel to the magnetization direction of the permanent magnet; and at least one edge of each embedded electrical insulation layer is neither parallel nor perpendicular to the magnetization direction of the permanent magnet.

2. The permanent magnet as claimed in claim 1, wherein each embedded electrical insulation layer is intersected with at least one edge of the permanent magnet at a predetermined angle in a lengthwise or width direction of the permanent magnet, and the predetermined angle ranges from 0° to 180°; and the at least one edge of the permanent magnet intersected with each embedded electrical insulation layer is defined as an intersected permanent magnet edge.

3. The permanent magnet as claimed in claim 2, wherein the plurality of embedded electrical insulation layers are intersected with a same edge on the first magnetic pole surface in the lengthwise or width direction of the permanent magnet.

4. The permanent magnet as claimed in claim 2, wherein the intersected permanent magnet edge comprises a first edge of the first magnetic pole surface and a second edge of the second magnetic pole surface in the lengthwise and width direction of the permanent magnet; or the intersected permanent magnet edge comprises a first edge of the first magnetic pole surface and a second edge of the second magnetic pole surface in the lengthwise direction of the permanent magnet;
or the intersected permanent magnet edge comprises a first edge of the first magnetic pole surface and a second edge of the second magnetic pole surface in the width direction of the permanent magnet; the first edge and the second edge are parallel.

5. The permanent magnet as claimed in claim 2, wherein the predetermined angle is 90°.

6. The permanent magnet as claimed in claim 1, wherein each embedded electrical insulation layer is intersected with at least two edges of the permanent magnet at a predetermined angle in a lengthwise or width direction of the permanent magnet, and the predetermined angle ranges from 0° to 180°; and the at least two edges of the permanent magnet intersected with each embedded electrical insulation layer are defined as intersected permanent magnet edges.

7. The permanent magnet as claimed in claim 6, wherein the intersected permanent magnet edges comprise a first edge, a second edge, a third edge and a fourth edge, the first edge and the second edge are disposed on the first magnetic pole surface in the lengthwise direction of the permanent magnet; or the first edge and the second edge are disposed on the first magnetic pole surface in the width direction of the permanent magnet, the first edge and the second edge are parallel; or the first edge and the second edge are disposed on the first magnetic pole surface in the lengthwise and width direction of the permanent magnet, the first edge and the second edge are parallel; the first edge and the second edge are parallel;
the third edge and the fourth edge are disposed on the second magnetic pole surface in the lengthwise direction of the permanent magnet; or the third edge and the fourth edge are disposed on the second magnetic pole surface in the width direction of the permanent magnet; or the third edge and the fourth edge are disposed on the second magnetic pole surface in the lengthwise and width direction of the permanent magnet; the third edge and the fourth edge are parallel.

8. The permanent magnet as claimed in claim 6, wherein the intersected permanent magnet edges comprise a first edge and a second edge, the first edge and the second edge are disposed on the first magnetic pole surface; or the first edge and the second edge are disposed on the second magnetic pole surface; or the first edge is disposed on the first magnetic pole surface and the second edge is disposed on the second magnetic pole surface; the first edge and the second edge are perpendicularly intersected.

9. The permanent magnet as claimed in claim 1, wherein each embedded electrical insulation layer is intersected with one set of opposite angles of the first magnetic pole surface in a diagonal direction of the permanent magnet or each embedded electrical insulation layer is intersected with one set of opposite angles of the second magnetic pole surface in a diagonal direction of the permanent magnet; or each embedded electrical insulation layer is intersected with one set of opposite angles of the first magnetic pole surface and the second magnetic pole surface in a diagonal direction of the permanent magnet.

10. The permanent magnet as claimed in claim 1, wherein each embedded electrical insulation layer is intersected with two sets of opposite angles of the first magnetic pole surface in a diagonal direction of the permanent magnet; or each embedded electrical insulation layer is intersected with two sets of opposite angles of the second magnetic pole surface in a diagonal direction of the permanent magnet; or each embedded electrical insulation layer is intersected with two sets of opposite angles of the first magnetic pole surface and the second magnetic pole surface in a diagonal direction of the permanent magnet.

11. The permanent magnet as claimed in claim 1, wherein at least one of the embedded electrical insulation layers is intersected with an edge of the first magnetic pole surface; or at least one of the embedded electrical insulation layers is intersected with an edge of the second magnetic pole surface; or at least one of the embedded electrical insulation layers is intersected with an edge of the first magnetic pole surface and the second magnetic pole surface, and at least one embedded electrical insulation layer is intersected with one set of opposite angles of the first magnetic pole surface; or at least one embedded electrical insulation layer is intersected with one set of opposite angles of the second magnetic pole surface; or at least one embedded electrical insulation layer is intersected with one set of opposite angles of the first magnetic pole surface and the second magnetic pole surface.

12. The permanent magnet as claimed in claim 1, wherein each embedded electrical insulation layer is intersected with three edges of the permanent magnet at a predetermined angle in the lengthwise or width direction of the permanent magnet, and the predetermined angle ranges from 0° to 180°.

13. The permanent magnet as claimed in claim 1, wherein each embedded electrical insulation layer is intersected with four edges of the permanent magnet at a predetermined angle in the lengthwise or width direction of the permanent magnet, and the predetermined angle ranges from 0° to 180°.

14. The permanent magnet as claimed in claim 1, wherein a slot is disposed in the permanent magnet; and the slot is filled with an insulation material or air, or an electrical insulation surface layer is disposed on an inner wall of the slot to obtain the embedded electrical insulation layer.

15. The permanent magnet as claimed in claim 1, wherein a cross section of the permanent magnet is rectangular or C-shaped.

16. A permanent magnet motor, comprising a stator, a rotor supported to rotate relative to the stator, and a plurality of permanent magnets disposed on the rotor, wherein the permanent magnet is the permanent magnet as claimed in claim 1; a first magnetic pole surface of the permanent magnet faces away from a center of the rotor in a radius direction of the rotor; and a second magnetic pole surface of the permanent magnet faces the center of the rotor in a radius of the rotor.

17. The permanent magnet motor as claimed in claim 16, wherein the permanent magnets are disposed in a rotor slot of the rotor or on an outer surface of the rotor.

18. A permanent magnet motor, comprising a stator, a rotor supported to rotate relative to the stator, and a plurality of permanent magnets disposed on the rotor, wherein the permanent magnet is the permanent magnet as claimed in claim 2; a first magnetic pole surface of the permanent magnet faces away from a center of the rotor in a radius direction of the rotor; and a second magnetic pole surface of the permanent magnet faces the center of the rotor in a radius of the rotor.

19. A permanent magnet motor, comprising a stator, a rotor supported to rotate relative to the stator, and a plurality of permanent magnets disposed on the rotor, wherein the permanent magnet is the permanent magnet as claimed in claim 3; a first magnetic pole surface of the permanent magnet faces away from a center of the rotor in a radius direction of the rotor; and a second magnetic pole surface of the permanent magnet faces the center of the rotor in a radius of the rotor.

20. A permanent magnet motor, comprising a stator, a rotor supported to rotate relative to the stator, and a plurality of permanent magnets disposed on the rotor, wherein the permanent magnet is the permanent magnet as claimed in claim 4; a first magnetic pole surface of the permanent magnet faces away from a center of the rotor in a radius direction of the rotor; and a second magnetic pole surface of the permanent magnet faces the center of the rotor in a radius of the rotor.
